(19) United States
(12) Patent Application Publication
(10) Pub. No.: US 2007/0096427 A1
(43) Pub. Date: May 3, 2007

(54) Powered attachment for a wheelchair

(76) Inventor: James Knaub, Long Beach, CA (US)

Correspondence Address: MARCIA A. DEVON;DEVON & ASSOCIATES, 400 OCEANGATE BLVD., SUITE 800, LONG BEACH, CA, 90802, US

(21) Appl. No.: 11/581,654

(22) Filed: Oct. 16, 2006

Related U.S. Application Data
(60) Provisional application No. 60/726,850, filed on Oct. 14, 2005.

(51) Int. Cl. A61G 5/10

(52) U.S. Cl. 280/304.1

(57) ABSTRACT

Disclosed is an improvement for a wheelchair of the type having a pair of generally parallel support bars, a footrest, and a plurality of footrest supporting wheels. The improvement comprises a crossbar, a center bar, a front wheel post, a front wheel, and a handlebar. Each end of the crossbar is connected to one of the support bars of the wheelchair with a crossbar mounting. The center bar is fixed at one end thereof proximate to a center point of the crossbar and terminates at the other end thereof at a front wheel post support which rotationally captures the front wheel post. A lower end of the front wheel post terminates in a pair of generally parallel fork posts between which the front wheel is axially mounted. A powered driving means rotationally drives the front wheel and is controlled by a throttle mounted on the handlebar. The handlebar is fixedly attached to a handlebar support of an upper end of the front wheel post. The center bar includes a pivoting joint for allowing the improvement to assume a linear operating position, whereby the footrest support wheels of the wheelchair are raised off of a ground surface and the combination of the wheelchair and the improvement act as a powered trike. The center bar may also assume a non-operating means whereby the footrest support wheels of the wheelchair contact the ground, thereby allowing the cross bar of the improvement to be manually disengaged from the wheelchair so that the wheelchair may be used traditionally.

This Application claims the benefit pursuant to 35 U.S.C. 119(e) of U.S. Provisional Patent Application Ser. No. 60/726,850 filed by the applicant on Oct. 14, 2005

### FIELD OF THE INVENTION

This invention relates to wheelchairs and, and more particularly, to a powered attachment for a wheelchair.

### DISCUSSION OF RELATED ART

Means for providing auxiliary power to a manually-driven wheelchair are known in the art. Such devices are useful for extending the distance a person may travel without tiring, as manually propelling a wheelchair is a laborious task. Examples of such devices are found in the following prior art patents:

| Patent Number | Inventor | Pub. Date |
|---|---|---|
| U.S. Pat. No. 6,766,871 | Sawyer | Jul. 27, 2004 |
| U.S. Pat. No. 6,729,422 | Chu et al. | May 4, 2004 |
| U.S. Pat. No. 5,651,422 | Casali | Jul. 29, 1997 |
| U.S. Pat. No. 5,494,126 | Meeker | Feb. 27, 1996 |
| U.S. Pat. No. 5,113,959 | Mastov et al. | May 19, 1992 |
| U.S. Pat. No. 5,050,695 | Kleinwolterink, Jr. | Sep. 24, 1991 |
| U.S. Pat. No. 5,016,720 | Coker | May 21, 1991 |
| U.S. Pat. No. 4,050,533 | Seamone | Sep. 27, 1977 |

Such devices are typically characterized by a mechanism attachable to a wheelchair that provides a motorized drive wheel that can selectively contact the ground to drive the wheelchair in a forward or reverse direction. Several such devices additionally provide steering means, as well.

However, such devices are relatively difficult to detach from the wheelchair to which they are mounted, as is often desired in closed or tight spaces such as indoors. To the extent that such devices are usable indoors, however, such devices are not capable of powering the wheelchair to which they are attached to any significant distance or at a significant speed. Prior art devices of this type are characterized by a compact, relatively small drive wheel, and as such they are limited both in the safe maximum speed at which they can operate, and the irregularity of the surface over which they can travel. None of these prior art devices would be suitable, for example, traveling over a gravel or dirt path. In open or outdoor situations, such as when a person desired to travel to a local supermarket several blocks away, for example, such prior art devices do not provide enough speed to make the trip a practical, short expedition. Such devices typically can only propel a wheelchair at a rate of two or three miles per hour. Further, such prior art devices are not well-suited for outdoor travel over irregular sidewalks, up and down driveway curbs, or even over rough or irregular terrain such as grass or dirt due to the size of the drive wheels typical of such devices.

Other wheelchair powering attachments have been devised that include larger drive wheels, and as such overcome the difficulty of powering a wheelchair over rough or uneven terrain. Such prior art devices are taught in the following prior art references:

| Patent Number | Inventor | Pub. Date |
|---|---|---|
| U.S. Pat. No. 6,669,222 | Barrett et al. | Dec. 30, 2003 |
| U.S. Pat. No. 5,501,480 | Ordelman et al. | Mar. 26, 1996 |
| U.S. Pat. No. 4,471,972 | Young | Sep. 18, 1984 |

While such devices provide an additional, relatively large front wheel so that irregular terrain may be more easily navigated, such devices are directed towards allowing the wheelchair occupant to propel the wheelchair manually using a chain and sprocket mechanism similar to that of a conventional bicycle. As a result, such devices are limited to a maximum speed at which the occupant can sustain manually, as well as a maximum distance before the occupant tires. Such devices, again, have a limited practical range, albeit over a greater variety of surfaces. A further drawback with many such devices is that they are relatively bulky and are not easily stored when not in use. Detaching such devices from the wheelchair involves the use of tools, with the exception of the '480 patent, which has a relatively complicated wheelchair attachment mechanism.

One notable prior art patent is U.S. Pat. No. 5,207,286 to McKelvey on May 4, 1993, which teaches a powered wheelchair attachment device that effectively converts a wheelchair into a powered, tricycle. However, while such a device does allow for long distance and higher-speed travel over a variety of surfaces, since it lifts the smaller front wheels of the wheelchair off of the ground, this device is anything but compact and easy to store. A complicated wheelchair attachment mechanism is included that requires the permanent addition of two cross-bars to the wheelchair.

Another notable prior art device is taught in U.S. Pat. No. 3,912,032 to Benz et al. on Oct. 14, 1975, in which a powered attachment with a large front wheel is relatively easily attached to a wheelchair. Again, however, the wheelchair must be significantly modified in order to be attachable to such a device.

Therefore, there is clearly a need for a powered wheelchair attachment that can be attached to an existing wheelchair without the need to modify the wheelchair. Further, such a device would be easily removed by the wheelchair user without the need to get out of the wheelchair or obtain help from a third party. Such a needed device would be relatively compact, easy to store, and relatively inexpensive to manufacture. Such a needed device would convert a wheelchair into a three-wheeled powered tricycle capable of traversing irregular terrain at a reasonably high rate of speed for an extended duration, thereby making longer distance trips more practical. The present device accomplishes these objectives and is safe to operate. The present invention is safer than prior designs because of the larger front wheel and steering geometry allows it to travel at higher speeds. Further, a spring mechanism is provided to stabilize the steering.

### SUMMARY OF THE INVENTION

The present device is an improvement for a wheelchair of the type having a pair of generally parallel support bars, a footrest, and a plurality of footrest supporting wheels. The improvement is comprised of generally a crossbar, a center bar, a front wheel post, a front wheel, and a handlebar means. Each end of the crossbar is connected to one of the support bars of the wheelchair with a crossbar mounting means.

Preferably the crossbar mounting means uses a ball lock pin for locking to the crossbar. As such, the crossbar may be removed from the wheelchair relatively easily by manually releasing the ball lock pin. Accordingly, it is relatively easy to convert the wheelchair into a powered vehicle, and vice versa, manually without requiring the use of tools.

The center bar is fixed at one end thereof proximate to a center point of the crossbar and terminates at the other end thereof at a front wheel post support. The center bar includes a pivoting joint that defines a lower center bar and an upper center bar pivotally interconnected thereby. The pivoting joint is pivotably fixed between an operating position wherein the lower and upper center bars are co-linear, and a non-operating position, wherein the lower and upper center bars are not co-linear. A locking sleeve is slidably retained on the center bar so as to slide over the pivoting joint when the pivoting joint is in the operating position, thereby preventing the pivoting joint from pivoting out of the operating position.

The front wheel post is rotationally captured by the front wheel post support. A lower end of the front wheel post terminates in a pair of generally parallel fork posts. The front wheel is axially mounted between the pair of fork posts and includes a rotational bearing around which the wheel may freely rotate. A powered driving means rotationally drives the front wheel and is controlled by a throttle means mounted on the handlebar means.

An upper end of the front wheel post terminates in a handlebar support. The handlebar is fixedly attached to the handlebar support of the front wheel post. Brakes may also be included on the handlebar means, as in known in the art.

In use, the crossbar mounting means of the improvement is mounted to the support bars of the manual wheelchair. An occupant of the wheelchair may then push forward on the handlebar so as to cause the pivoting joint to pivot such that the lower center bar and the upper center bar become co-aligned, whereby the locking sleeve slides down by gravity over the pivoting joint. The pivoting joint is formed with two hinges pivotally connected. Accordingly, the footrest supporting wheels are raised above a ground surface and the wheelchair may now be driven and steered by the occupant, the combination of which acts as a powered three-wheel vehicle.

The present invention is a powered wheelchair attachment that can be attached to an existing manual wheelchair without the need to modify the wheelchair. Further, such a device is easily removed by the wheelchair user without the need to get out of the wheelchair, use tools, or obtain help from a third party. The present device is relatively compact, easy to store, and relatively inexpensive to manufacture. Further, the present invention converts a manual wheelchair into a three-wheeled powered tricycle capable of traversing irregular terrain at a reasonably high rate of speed for an extended duration, thereby making longer distance trips more practical. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a side elevational view of the invention as attached to a wheelchair and in a non-operating position;

FIG. 2 is a side elevational view of the invention as attached to the wheelchair and in an operating position, elevating footrest supporting wheels above a ground surface;

FIG. 3 is a partial perspective view of the invention, illustrating in further detail a crossbar attached at both ends thereof to the wheelchair, and a pivoting joint of a center bar in the non-operating position;

FIG. 4 is a partial perspective view of the invention, illustrating in further detail the pivoting joint of the center bar in the operating position, a locking sleeve fixed thereover;

FIG. 5 is a partial perspective view of the invention, illustrating in further detail a crossbar mounting means for attaching the crossbar to the wheelchair;

FIG. 6 is a partial top plan view of the invention, illustrating lateral slide adjustment means of the crossbar;

FIG. 7 is a partial perspective view of a handlebar means of the invention, illustrating a throttle means and a breaking means thereof; and

FIG. 8 is a partial side elevational view of a spring means of the invention, taken generally along lines 8-8 of FIG. 2.

### DETAILED DESCRIPTION OF THE PREFERRED EMBODIMENT

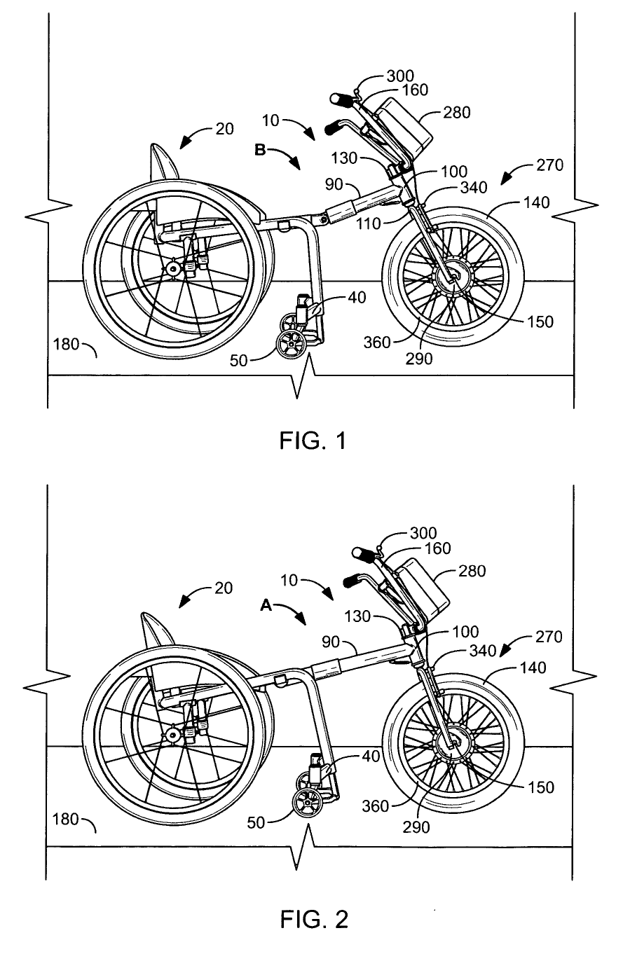

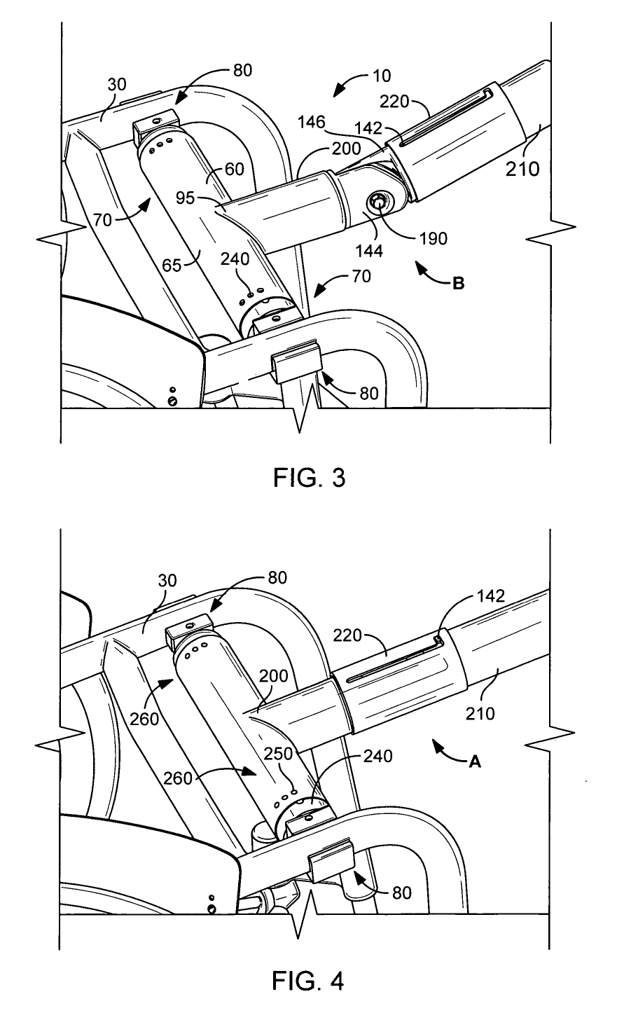

FIG. 1 illustrates an improvement 10 for a wheelchair 20 of the type having a pair of generally parallel support bars 30 (FIGS. 3 and 4), a footrest 40, and a plurality of footrest supporting wheels 50. For example, a wheelchair 20 sold under the brand name “Typhoon W.K.-'00” is well-suited for use with the improvement 10 of the present invention.

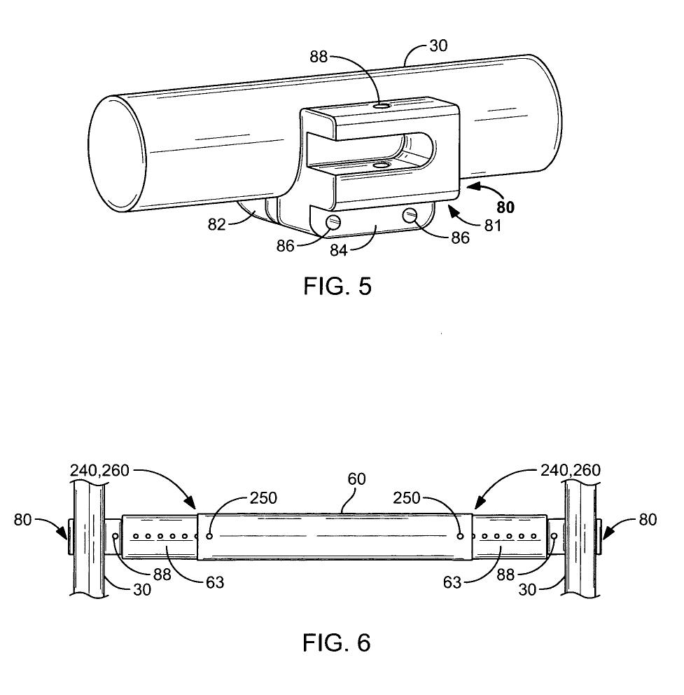

The improvement 10 is comprised of generally a crossbar 60 (FIG. 3 and 4), a center bar 90, a front wheel post 100 which includes forks 110, a front wheel 140, and a handlebar means 160. Each end 70 of the crossbar 60 is connected to one of the support bars 30 of the wheelchair 20 with a crossbar mounting means 80 (FIGS. 5 and 6). The crossbar mounting means 80 is preferably a split clamp 81 commonly used to fix items to tubular bars (FIG. 5). The split clamp 81 preferred in the present invention comprises an outer clamp 82 and an inner clamp 84 bolted to each other through mounting holes 86 using an Allan-head bolt with a Nylock-type nut. As such, the crossbar 60 may be firmly attached to the support bars 30 so that, even with a strong moment force or vibrational forces applied to the center bar 90 the crossbar mounting means 80 of each end 70 of the crossbar 60 will firmly hold the support bars 30.

Preferably the hole 88 of each inner clamp 84 accepts a ball lock pin (not shown) for locking the clamp 81 to the crossbar 60. As such, once initially set, the clamp 81 may be removed from the crossbar 60 relatively easily by manually releasing the ball lock pin. Accordingly, it is relatively easy to convert the wheelchair 20 into a powered vehicle, and vice versa manually without requiring the use of tools.

The center bar 90 is fixed at one end 95 thereof proximate to a center point 65 of the crossbar 60 and terminates at the other end 98 thereof at a front wheel post support 100. The center bar 90 includes a first hinge 144 and a second hinge 146, forming a pivoting joint 190, best illustrated in FIG. 3, that defines a lower center bar 200 and an upper center bar 210 pivotally interconnected thereby. The pivoting joint 190 is pivotably fixed between an operating position A (FIG. 4) wherein the lower and upper center bars 200,210 are co-linear, and a non-operating position B (FIG. 3), wherein the lower and upper center bars 200,210 are not co-linear. A locking sleeve 220 is included of greater inside diameter than the outer diameter of the center bar 90, so that the locking sleeve 220 is slidably retained on the center bar 90. The locking sleeve 220 may be slid over the pivoting joint when the pivoting joint is in the operating position A, whereby the locking sleeve 220 prevents the pivoting joint from pivoting away from the operating position A. A sleeve locking means 230, such as a pin 142 protruding from the center bar 90 engaging a slot of the locking sleeve 220, locks the sleeve 220 over the pivoting joint 190, thereby locking the pivoting joint 190 in the operating position A. To configure the wheelchair 20 and the improvement 20 into the non-operating position B, the sleeve 220 may be disengaged from the pivoting joint 190 such as by rotating it about the center bar 90 and sliding it up towards the front wheel post support 100, thereby allowing the pivoting joint 190 to pivot into the non-operating position B.

Preferably each crossbar mounting means 80 includes a rotational adjustment mechanism 240 and a slide adjustment 260, such as an inner crossbar 63 telescopically and rotationally engaged with the crossbar 65 (FIG. 6). As such, a rotational locking mechanism 250, such as a detent pin, may be used to rotationally and slidably fix each inner crossbar 63 with respect to the outer crossbar 65. In this way, a variety of wheelchair types can be easily adapted with the improvement 10, as the crossbar 65 may accommodate varying distances between the support bars 30, often referred to as seat rails.

The front wheel post 100 is rotationally captured by the front wheel forks 110, as is common with bicycles of the prior art. A lower end 112 of the front wheel post 110 terminates in a pair of generally parallel fork posts 120. An upper end 114 of the front wheel post 110 terminates in a handlebar support 130. Preferably a first spring mount 370 is fixed proximate to the front wheel post support 100 on a lower side 380 of the crossbar 90, and the front wheel post 110 includes a second spring mount 390 fixed to the lower end thereof, such that a spring 400 may be interconnected between the first and second spring mounts 380,390 (FIG. 8). As such, the spring 400 urges the wheel 140 into coplanar alignment with the longitudinal axis of the center bar 90 so that that wheelchair 20 and the improvement 10 maintain a generally straight default course when driven. Thus, if the user momentarily loses control, the spring mechanism will stabilize the chair, maintaining the center of gravity.

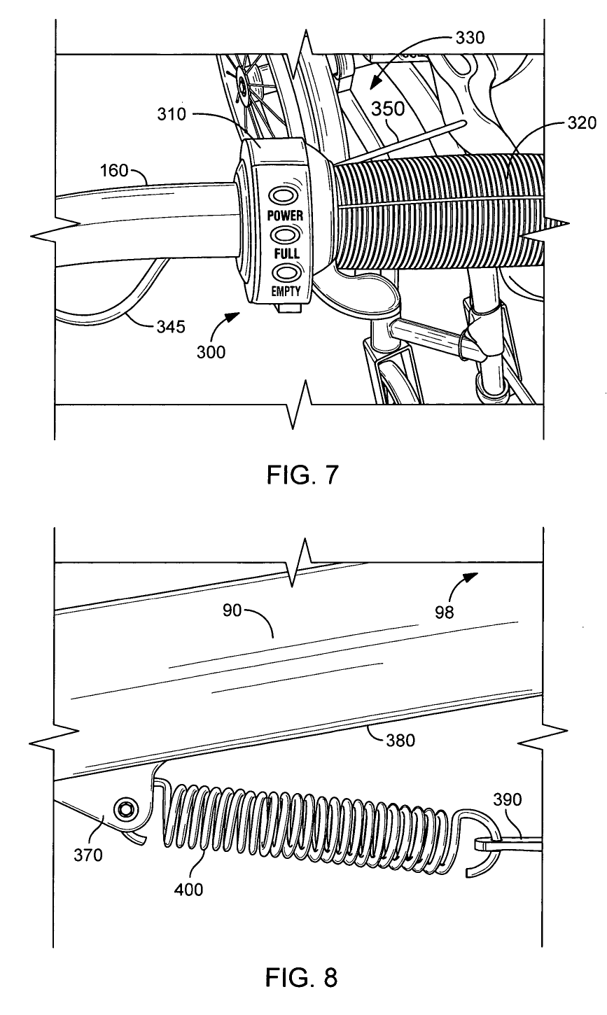

The front wheel 140 is axially mounted between the pair of fork posts 120 and includes a rotational bearing 150 around which the wheel 140 may freely rotate. A power source 270, such as an electric battery 280 electrically connected through a throttle 300 to an electric motor 290 in the wheel 140, rotationally drives the front wheel 140 in a forward direction. The electric motor 290 is mechanically interconnected with the front wheel 140 such that rotation of the electric motor 290 causes forward rotation of the wheel 140. The throttle 300 is preferably an electric current regulator 310 attached to the handlebar 160 proximate to a handgrip 320 thereof (FIG. 7).

The handlebar 160 is attached to the handlebar support 130 of the front wheel post 110, as is commonly known in the art of bicycles and the like. The electric battery 280 is preferably attached to the handlebar 160 so as to not block the visibility of the occupant, but so as to be readily accessible for connecting recharging cables or the like thereto. Preferably the battery 280 is a 36V DC cell, or three 12V DC cells arranged in series. It is has been found that such a batter 280 is capable of powering a 600 Watt DC brushed electric motor so as to enable the wheelchair 20 and the improvement 10 to achieve in excess of 16 miles-per-hour for a distance in excess of twenty miles.

A breaking means 300 may be included, such as a caliper 340 mounted around the front wheel 140 (FIG. 2). The caliper 340 is mechanically connected, such as through a cable 345 to a hand lever 350 (FIG. 7) mounted proximate the hand grip 320 of the handlebar means 160. When the hand grip 320 is actuated, the cable 345 causes the caliper 340 to squeeze a portion 360 of the front wheel 140 therebetween to inhibit rotation of the front wheel 140 (FIG. 2).

In use, the crossbar mounting means 80 of the improvement 10 is mounted to the support bars 30 of the wheelchair 20. The lateral slide adjustment mechanism 260 are adjusted and locked so that crossbar 60 is firmly mounted between the support bars 30. An occupant of the wheelchair 20 (not shown), sitting therein, may then push forward on the handlebar means 160 so as to cause the pivoting joint 190 to pivot such that the lower center bar 200 and the upper center bar 210 become co-aligned, whereby the locking sleeve 220 slides down by gravity over the pivoting joint 190. Accordingly, the footrest supporting wheels 50 are raised above a ground surface 180 (FIG. 2) and the wheelchair 20 may now be driven and steered by the occupant, the combination of which acts as a powered three-wheel vehicle.

To disengage the wheelchair 20 from the improvement 10, the locking sleeve 220 is rotated and pushed forward, such that the pivoting joint 190 assumes the non-operating position B (FIG. 1). The ball lock pins of the crossbar 60 are then manually pulled, freeing the crossbar 60 from the crossbar mounting mechanism 80, and the crossbar 60 may be lowered to the ground 180. As the pivoting joint 190 only pivots in one direction, around a horizontal left-to-right axis (not shown), the improvement 10 will maintain itself upright on the ground 180 even when not attached to the wheelchair 20. As such, the improvement 10, by itself, is easy to handle and store. The wheelchair 20, once disengaged from the improvement 10, may be used traditionally such as indoors or in close spaces where use with the improvement is not practical or desired.

While a particular form of the invention has been illustrated and described, it will be apparent that various modifications can be made without departing from the spirit and scope of the invention. For example, the materials used for the cross-bar 60 and the center bar 90, or the handlebar 160, may be changed to any suitable rigid material other than the preferred titanium alloy. Likewise, the particular nature of the crossbar mounting mechanism 80 may be altered to any suitable mounting means known now or in the future. Accordingly, it is not intended that the invention be limited, except as by the appended claims.

What is claimed is:

1. An improvement for a wheelchair having first and second support bars, a footrest, and a plurality of footrest supporting wheels, the improvement comprising:
a front wheel axially mounted between the pair of fork posts, the front wheel including a rotational bearing around which the wheel may freely rotate;
a front wheel post mounted to the front wheel while permitting rotation of the front wheel;
a crossbar having a first end, a second end and a center point, said first end of the crossbar connected to the first support bars and said second end connected to said second support bar; and
a center bar having a first end including a first hinge and a second end including a second hinge, said first hinge pivotally connected to said second hinge at a pivot joint, said pivot joint proximate to said center point of said crossbar, said center bar terminating at said second end at said front wheel post, and said center bar pivoting at pivot point such that said center bar is moved from a first position to a second position;

2. The improvement of claim 1 wherein said center bar includes a pin and further including a locking sleeve for receiving said pin such that when said pin is received by said locking sleeve, said center bar is secured in the second position.

3. The improvement of claim 2 wherein said center bar and said locking sleeve further each include sleeve locking means for locking the locking sleeve over the pivot joint, thereby locking the pivoting joint in said second position.

4. The improvement of claim 1 wherein each crossbar mount includes a rotational adjustment mechanism and a rotational locking mechanism, the rotational adjustment mechanism allowing the crossbar to be attached and secured to the support bars at any angle, and the rotational locking mechanism for selectively and rotationally locking the rotational adjustment mechanism to the crossbar.

5. The improvement of claim 1 wherein each crossbar mounting means includes a lateral slide adjustment mechanism, whereby the crossbar mounting may be slidably adjusted to fit between support bars separated by varying distances.

6. The improvement of claim 1 further including a means for driving rotationally driving the front wheel.

7. The improvement of claim 6 wherein the means for driving includes an electric battery electrically connected to an electric motor through a throttle means, the electric motor mechanically interconnected with the front wheel to rotationally drive the front wheel.

8. The improvement of claim 7 wherein the throttle means is an electric current regulator attached to the handlebar means proximate to a handgrip thereof.

9. The improvement of claim 8 wherein the driving means rotationally drives the front wheel in a forward direction.

10. The improvement of claim 1 further including a breaking means for braking rotational motion of the front wheel.

11. The improvement of claim 10 wherein the means for braking comprises a caliper mounted around the front wheel, the caliper mechanically connected to a hand lever mounted proximate the hand grip of the handlebar means, the caliper acting to squeeze a portion of the front wheel there between upon actuation of the hand lever to inhibit rotation of the front wheel.

12. The improvement of claim 1 wherein the center bar further includes a first spring mount affixed proximate the front wheel post support on a lower side thereof, and the front wheel post includes a second spring mount affixed to the lower end thereof, spring means interconnecting the first and second spring mounts, whereby the spring means urges the wheel into coplanar alignment with the longitudinal axis of the center bar.
